(19) United States
(12) Patent Application Publication
(10) Pub. No.: US 2019/0248407 A1
(43) Pub. Date: Aug. 15, 2019

(54) STEERING CONTROL APPARATUS AND STEERING CONTROL SYSTEM

(71) Applicant: DENSO CORPORATION, Kariya-city (JP)

(72) Inventors: Koichi NAKAMURA, Kariya-city (JP); Nobuyori NAKAJIMA, Kariya-city (JP); Go ENDOH, Kariya-city (JP); Yosuke OGI, Kariya-city (JP); Atsuko OKA, Kariya-city (JP)

(21) Appl. No.: 16/267,743

(22) Filed: Feb. 5, 2019

(30) Foreign Application Priority Data
Feb. 13, 2018 (JP) 2018-23061

(51) Int. Cl. B62D 5/04

(52) U.S. Cl. CPC B62D 5/0463; B62D 5/0481

(57) ABSTRACT

A steering control apparatus controlling an electric power steering apparatus includes a first control part and a second control part. The first control part communicates with an external device and executes a specific process. The second control part communicates with the first control part and executes the specific process. The first control part can acquire first information and second information. When all of the first information and the second information are positive, the first control part transmits positive information to the external device. When a part of the first information and the second information is negative, the first control part transmits negative information to the external device.

### CROSS REFERENCE TO RELATED APPLICATION

The present application claims the benefit of priority from Japanese Patent Application No. 2018-23061 filed on Feb. 13, 2018. The entire disclosure of the above application is incorporated herein by reference.

### TECHNICAL FIELD

The present disclosure relates to a steering control apparatus and a steering control system.

### BACKGROUND

An electric power steering apparatus that includes a controller controlling driving of a motor is proposed.

### SUMMARY

The present disclosure provides a steering control apparatus that may include a first control part and a second control part.

The first control part may acquire first information related to an execution propriety state of a specific process of the first control part and second information related to the execution propriety state of the specific process of the second control part. When all of the first information and the second information are positive, the first control part may transmit positive information to an external device. When a part of the first information and the second information is negative, the first control part may transmit negative information to the external device. Further, the present disclosure provides a steering control system including the steering control apparatus and the electric power steering apparatus. The electric power steering apparatus has a first sensor that may detect a first detection value and output the first detection value to the first control part, and a second sensor that may detect a second detection value and output the second detection value to the second control part. The specific process may be a sensor correction process in which a detection value acquired by at least one of the first sensor or the second the second sensor may be corrected.

### BRIEF DESCRIPTION OF DRAWINGS

The above and other objects, features and advantages of the present disclosure will become more apparent from the following detailed description made with reference to the accompanying drawings. In the drawings:

FIG. 1 is a schematic diagram showing a steering system according to a first embodiment;

FIG. 2 is a cross-sectional view showing a driving device according to the first embodiment;

FIG. 3 is a cross-sectional view taken along a line III-III in FIG. 2;

FIG. 4 is a block diagram showing an EPS-ECU according to the first embodiment;

FIG. 5 is a block diagram exemplifying a connection relation between the EPS-ECU and the external device according to the first embodiment;

FIG. 6 is a flowchart illustrating a reprograming start process according to the first embodiment;

FIG. 7 is a flowchart illustrating a reprograming completion notification process according to the first embodiment;

FIG. 8 is a flowchart illustrating a reprograming completion notification process according to the first embodiment;

FIG. 9 is a flowchart illustrating a sensor correction process of a first control part according to a second embodiment;

FIG. 10 is a flowchart illustrating the sensor correction process of a second control part according to the second embodiment;

FIG. 11 is a block diagram showing an EPS-ECU according to a third embodiment; and

FIG. 12 is a block diagram exemplifying a connection relation between the EPS-ECU and the external device according to the third embodiment.

### DETAILED DESCRIPTION

An electric power steering apparatus includes a controller controlling driving of a motor. For example, an EPS motor control part of comparative example 1 includes a controller that has two systems independently drive-controlling an electric motor.

A comparative example 1 describes a configuration that includes multiple control parts. According to the configuration, when each control part executes a same process, a part of the control parts executes the process and the other control part does not execute the process. A state for the process is unmatched between the controllers, and thereafter difficulties for the control may occur. For example, in a case of the program update process (also referred to as “a reprogramming process”) described in a comparative example 2, when a part of the controllers executes the reprograming and the other controller does not execute the reprograming process, program may be unmatched between the controllers.

The present disclosure provides a steering control apparatus that controls an electric power steering apparatus including a rotation electric machine, and includes a first control part and a second control part. The first control part communicates with an external device and executes a specific process in response to a request from the external device. The second control part communicates with the first control part, receives a command from the first control part, and executes the specific process. The specific process may include, for example, a reprograming process or a sensor correction process.

The first control part can acquire first information related to an execution propriety state of the specific process of the first control part and second information related to the execution propriety state of the specific process of the second control part. When all of the first information and the second information are positive, the first control part transmits positive information to the external device. When a part of the first information and the second information is negative, the first control part transmits negative information to the external device.

It may be possible to execute the specific process by the multiple control parts cooperating with each other. For example, even when the second control part is not connected to the external device, it may be possible to execute the specific process. Further, it may be possible to appropriately notify the external apparatus of execution propriety state for the specific process. The present disclosure provides a steering control system including the steering control apparatus and the electric power steering apparatus. The electric power steering apparatus has a first sensor that detects a first detection value and outputs the first detection value to the first control part, and a second sensor that detects a second detection value and outputs the second detection value to the second control part. The specific process is a sensor correction process in which a detection value acquired by at least one of the first sensor or the second the second sensor is corrected.

### First Embodiment

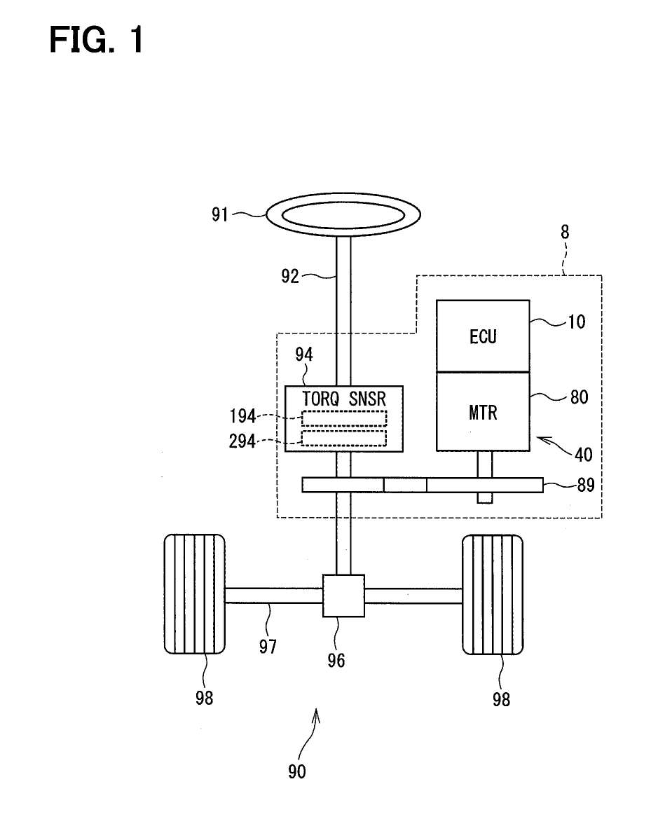

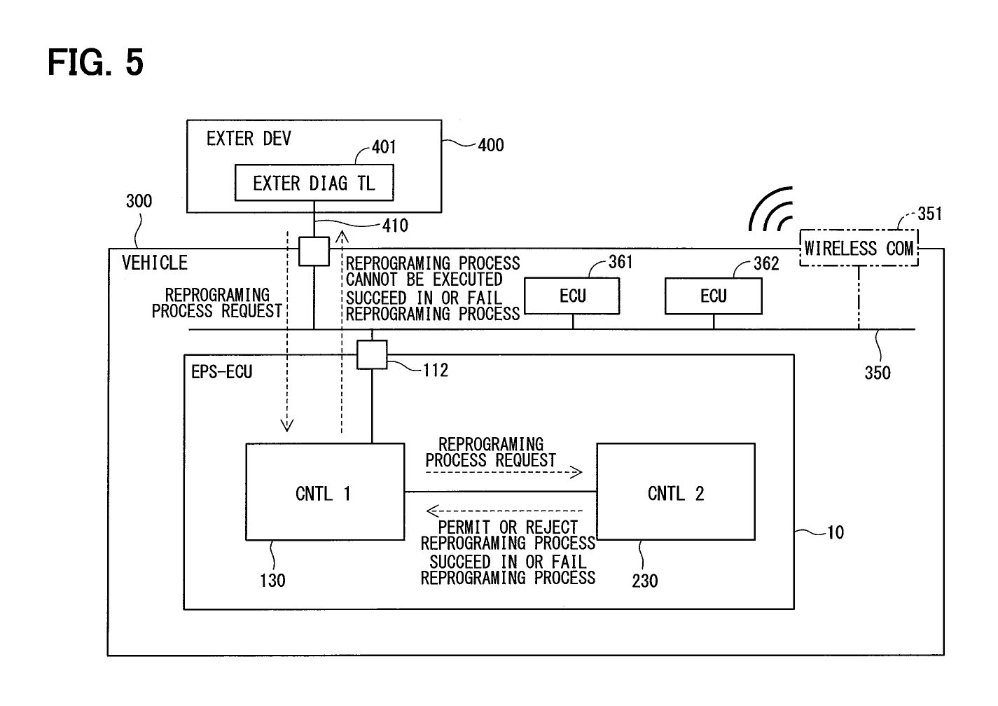

An electronic controller will be described with reference to the drawings. In multiple embodiments, a description will be omitted by applying an identical reference to actually similar configuration. As shown in FIG. 1, an EPS-ECU 10 is provided as a steering control apparatus according to the first embodiment. A motor 80 is provided as a rotation electric machine. The EPS-ECU 10 is applied to an electric power steering apparatus 8 together with the motor 80. The electric power steering apparatus 8 assists a steering operation of a vehicle 300 (see FIG. 5). Hereinafter, the EPS-ECU 10 may be simply referred to as an ECU 10. FIG. 1 shows a whole configuration of a steering system 90 including the electric power steering apparatus 8. The steering system 90 includes a steering wheel 91, a steering shaft 92, a pinion gear 96, a rack shaft 97, a wheel 98, the electric power steering apparatus 8, or the like. EPS is an abbreviation for electric power steering.

The steering wheel 91 is connected to the steering shaft 92. A torque sensor 94 detects a steering torque Ts, and is placed in the steering shaft 92. The torque sensor 94 includes a first torque detector 194 and a second torque detector 294. The pinion gear 96 is provided at a tip of the steering shaft 92. The pinion gear 96 meshes with the rack shaft 97. A pair of the wheels 98 is coupled at both ends of the rack shaft 97 via, for example, a tie rod or the like.

When a driver of the vehicle rotates the steering wheel 91, the steering shaft 92 connected to the steering wheel 91 rotates. A rotational motion of the steering shaft 92 is converted into a linear motion of the rack shaft 97 by the pinion gear 96. The pair of wheels 98 is steered to an angle corresponding to the displacement amount of the rack shaft 97.

The electric power steering apparatus 8 includes a driving device 40 that includes the motor 80 and the ECU 10, and includes a reduction gear 89 or the like as a power transmission mechanism that reduces the rotation of the motor 80 and transmits the rotation to the steering shaft 92. The electric power steering apparatus 8 of the first embodiment is “a column assist type”. It may alternatively be “a rack assist type” that transmits the rotation of the motor 80 to the rack shaft 97. In the embodiment, the steering shaft 92 corresponds to “a driving target”.

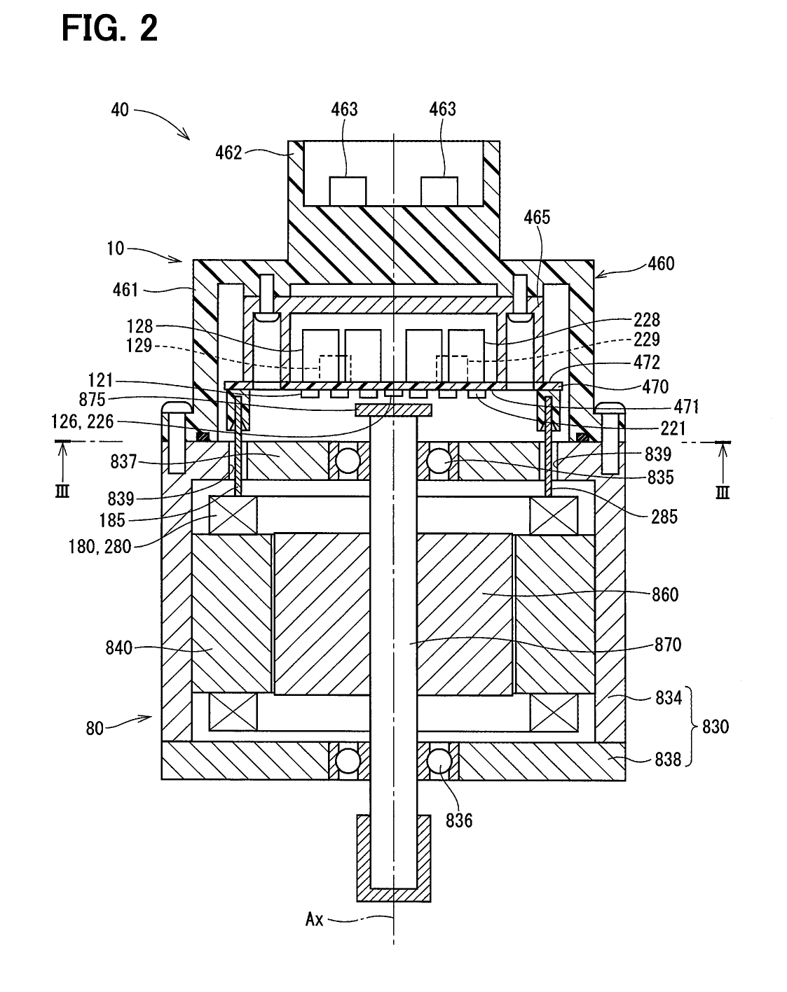

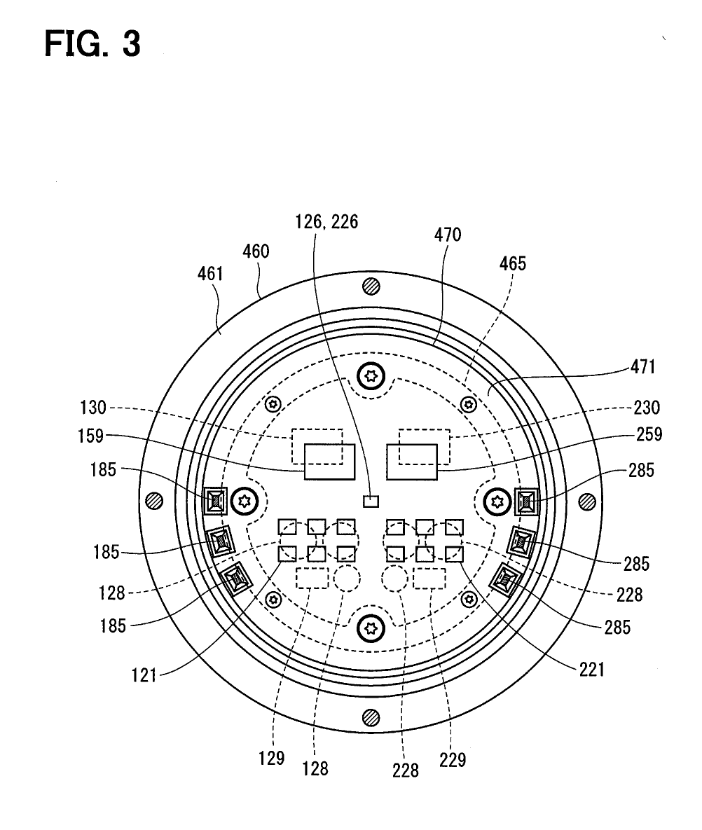

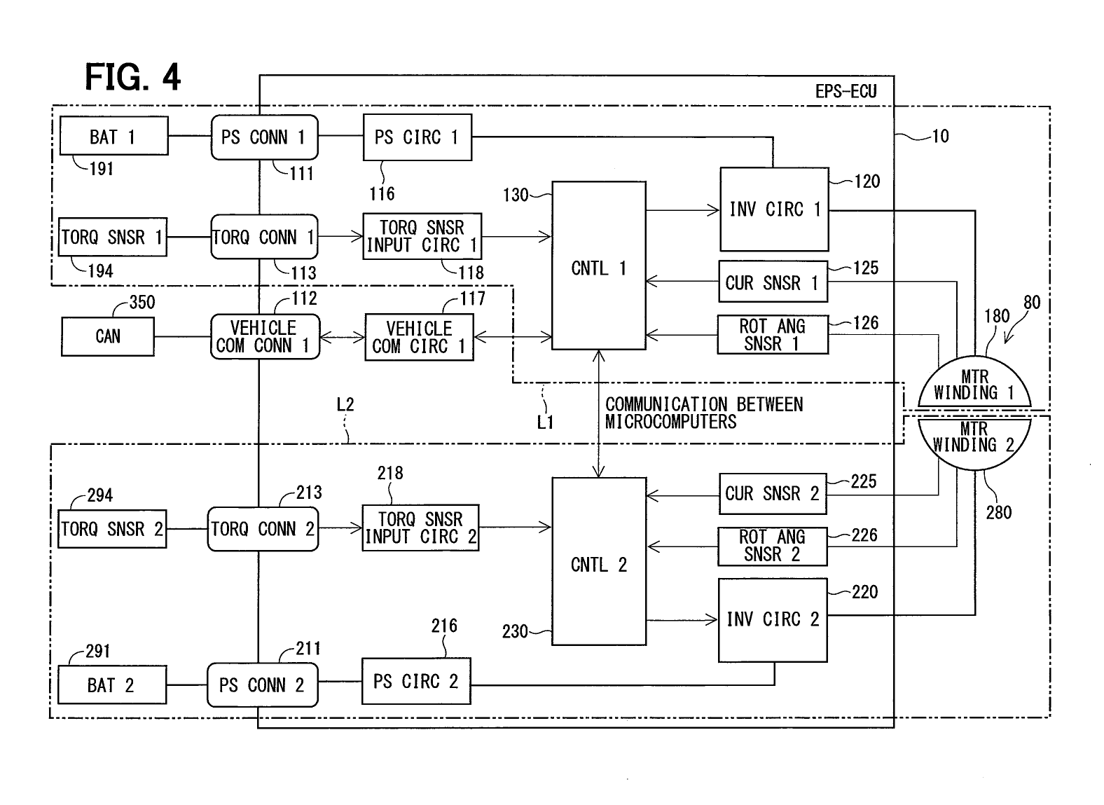

As shown in FIG. 2 and FIG. 3, the motor 80 outputs a whole or a part of an assist torque required for a steering operation. The motor 80 is driven by electric power supplied from batteries 191 and 291 (see FIG. 4) as a direct current power supply to rotate the reduction gear 89 in forward and reverse directions. The motor 80 is a three-phase brushless motor and has a rotor 860 and a stator 840 (see FIG. 4).

The motor 80 has a first motor winding 180 and a second motor winding 280 as a winding set. In the drawings, accordingly, the first motor winding 180 may be referred to as “a motor winding 1” and the second motor winding 280 may be referred to as “a motor winding 2”. According to the other configuration too, the term “first” may be described as suffix “1”, and the term “second” may be described as suffix “2”. The motor windings 180 and 280 have same electrical characteristics. For example, as shown in FIG. 3, the motor windings 180 and 280 are wound on the common stator 840 in a cancel winding form by shifting an electrical angle of 30 [deg] from each other. Correspondingly, phase currents having a phase difference φ of 30 [deg] are controlled to be supplied to the motor windings 180 and 280 (see FIG. 3). By optimizing an energization phase difference, the output torque is improved. It may be possible to reduce the sixth torque ripple. It may be possible to maximize advantage of cancelling a noise and a vibration since the phase difference energization averages the current. In addition, heat generation is averaged. It may be possible to reduce error between systems depending on temperature such as detection values of each sensor, torque, or the like. It may be possible to average a current amount capable of energization.

A combination of the first inverter circuit 120 and the first control part 130 or the like related to a driving control for the first motor winding 180 may be referred to as a first system L1. A combination of the second inverter circuit 220 and the second control part 230 or the like related to the driving control of the second motor winding 280 may be referred to as a second system L2. In the embodiment, the inverter circuits 120 and 220 correspond to “a driving circuit”. Reference numerals having 100 is basically assigned to the configuration relating to the first system L1. Reference numerals having 200 is basically assigned to the configuration relating to the second system L2. In the first system L1 and the second system L2, same reference numbers in the least significant two digits are assigned to the similar configuration.

In the driving device 40 of the first embodiment, the ECU 10 is integrally provided on a first side in an axial direction of the motor 80. That is, the driving device is provided in “a mechanically-electrically integrated type”. The motor 80 and the ECU 10 may alternatively be placed separately. The ECU 10 is positioned coaxially with an axis Ax of a shaft 870 on the side opposite to an output shaft of the motor 80. The ECU 10 may alternatively be placed on the output shaft side of the motor 80. By adopting the mechanically-electrically integrated type, it may be possible to efficiently position the ECU 10 and the motor 80 in a vehicle having restriction for mounting space.

The motor 80 includes the stator 840, the rotor 860 and a housing 830 that houses the stator 840 and the rotor 860, or the like. The stator 840 is fixed to the housing 830 and is wounded by the motor windings 180 and 280. The rotor 860 is placed radially inside the stator 840 to be rotatable relative to the stator 840.

The shaft 870 is fitted in the rotor 860 to rotate integrally with the rotor 860. The shaft 870 is supported by bearings 835 and 836 so as to rotate to the housing 830. An end of the shaft 870 on an ECU 10 side protrudes from the housing 830 to the ECU 10 side. A magnet 875 is placed at the end of the shaft 870 on the ECU 10 side.

The housing 830 has a bottomed cylindrical case 834 including a rear end frame 837, and has a front end frame 838 placed on an open side of the case 834. The case 834 and the front end frame 838 are fastened to each other by bolts or the like. A lead wire insertion hole 839 is formed in the rear end frame 837. Lead wires 185 and 285 are connected to each phase of the motor windings 180 and 280. The lead wires 185 and 285 are inserted through the lead wire insertion hole 839. The lead wires 185 and 285 are taken out from the lead wire insertion hole 839 to the ECU 10 side and connected to a circuit board 470.

The ECU 10 includes a cover 460, a heat sink 465 fixed to the cover 460, the circuit board 470 fixed to the heat sink 465 and each kind of other electronic components mounted on the circuit board 470, or the like.

The cover 460 protects the electronic component from external impacts, and prevents dust, water, or the like from entering into the ECU 10. The cover 460 is formed by integrating a cover body 461 and a connector part 462. The connector part 462 may alternatively be separated from the cover body 461. A terminal 463 of the connector part 462 is connected to the circuit board 470 via a wiring (not shown) or the like. The number of the connector and the number of the terminal may conveniently be changeable corresponding to the number of a signal or the like. The connector part 462 is placed at the end in an axial direction of the driving device 40, and is open on an opposite side to the motor 80. The connector part 462 includes each connector described later.

The circuit board 470 is, for example, a printed circuit board, and is positioned to face the rear end frame 837. On the circuit board 470, the electronic components of the first and second systems are mounted independently, so that the two systems are provided in a fully redundant configuration. In the embodiment, the electronic component is mounted on one circuit board 470. The electronic component may alternatively be mounted on multiple circuit boards.

Of two main surfaces of the circuit board 470, one surface on the side of the motor 80 may be referred to as a motor surface 471 and the other surface opposite from the motor 80 may be referred to as a cover surface 472. As shown in FIG. 3, switching elements 121 configuring the inverter circuit 120, switching elements 221 configuring the inverter circuit 220, rotation angle sensors 126 and 226, custom ICs 159 and 259 or the like are mounted on the motor surface 471. The rotation angle sensors 126 and 226 are mounted at positions facing the magnet 875 so as to be capable of detecting a change in the magnetic field caused by rotation of the magnet 875.

Capacitors 128 and 228, inductors 129 and 229, and microcomputers or the like configuring the control parts 130 and 230 are mounted on the cover surface 472. In FIG. 3, reference numerals “130” and “230” are assigned to the microcomputers configuring the control parts 130 and 230, respectively. The capacitors 128 and 228 smoothen electrical power input from batteries 191 and 291 (see FIG. 4). The capacitors 128 and 228 assist electric power supply to the motor 80 by storing electric charge. The capacitors 128 and 228 and the inductors 129 and 229 configure a filter circuit. The filter circuit reduces a noise transmitted from the other device that shares the batteries 191 and 291, and also reduces a noise transmitted to the other device that shares the batteries 191 and 291 from the driving device 40. Though not shown in FIG. 3, power supply circuits 116 and 216, motor relays, current sensors 125 and 225 or the like are also mounted on the motor surface 471 or the cover surface 472.

As shown in FIG. 4, the ECU 10 includes the inverter circuits 120 and 220, the control circuits 130 and 230, or the like. Power supply connectors 111 and 211, torque connectors 113 and 213, and a vehicle communication connector 112 are placed in the ECU 10. The first power supply connector 111 is connected to a first battery 191 and the second power supply connector 211 is connected to a second battery 291. The first power supply connector 111 is connected to the first inverter circuit 120 via the first power supply circuit 116. The second power supply connector 211 is connected to the second inverter circuit 220 via the second power supply circuit 216. The power supply circuits 116 and 216 correspond to, for example, power supply relays.

The vehicle communication connector 112 is connected to a vehicle communication network 350. The vehicle communication network 350 is exemplified by a CAN (controller area network) in FIG. 4. However, any standard such as CAN-FD (CAN with flexible data rate) and FlexRay may be employed.

The torque connectors 113 and 213 are connected to the torque sensor 94. In detail, the first torque connector 113 is connected to the first torque detector 194 of the torque sensor 94. The second torque connector 213 is connected to the second torque detector 294 of the torque sensor 94. In FIG. 4, the first torque detector 194 may be described as “a torque sensor 1” and the second torque detector 294 may be described as “a torque sensor 2”.

The first control part 130 can acquire a torque signal Ts relating to a steering torque Ts from the first torque detector 194 of the torque sensor 94 via the torque connector 113 and a torque sensor input circuit 118. The second control part 230 can acquire the torque signal Ts relating to the steering torque Ts from the second torque detector 294 of the torque sensor 94 via the torque connector 213 and a torque sensor input circuit 218. The control parts 130 and 230 calculate the steering torque Ts based on the torque signal.

The first inverter circuit 120 is a three-phase inverter having six switching elements 121. The first inverter circuit 120 converts electric power supplied to the first motor winding 180. The switching elements 121 are controlled to turn on and off based on control signals output from the first control part 130. The second inverter circuit 220 is a three-phase inverter having six switching elements 221. The second inverter circuit 220 converts the electric power supplied to the second motor winding 280. The switching elements 221 are controlled to turn on and off based on control signals output from the second control part 230.

The first current sensor 125 detects the current energized to each phase of the first windings 180, and outputs a detection value to the first control part 130. The second current sensor 225 detects the current energized to each phase of the second windings 280, and outputs a detection value to the second control part 230.

The first rotation angle sensor 126 detects a rotation angle of the motor 80, and outputs a detection value to the first control part 130. The second rotation angle sensor 226 detects the rotation angle of the motor 80, and outputs a detection value to the second control part 230. In the embodiment, the first current sensor 125, the first rotation angle sensor 126, and the first torque detector 194 correspond to “a first sensor”. The second current sensor 225, the second rotation angle sensor 226, and the second torque detector 294 corresponds to “a second sensor”.

Electric power is supplied to the first control part 130 via the first power supply connector 111 and a regulator (not shown) or the like. The electric power is supplied to the second control part 230 via the second power supply connector 211 and the regulator (not shown) or the like. The first control part 130 and the second control part 230 are placed to be communicable with each other between the control parts 130 and 230. Conveniently, the communication between the control parts 130 and 230 may be referred to as “an inter-microcomputer communication”. As a communication method between the control parts 130 and 230, any method such as a serial communication such as SPI or SENT, a CAN communication, a FlexRay communication may be employed.

Each of the control parts 130 and 230 is mainly configured from a microcomputer or the like, and internally includes a CPU, a ROM, a RAM, an I/O (not shown), a bus line for connecting these configurations, or the like. Each process executed by the ECUs 130 and 230 may be software process or may be hardware process. The software process may be implemented by causing the CPU to execute a program. The program may be stored beforehand in a memory device such as a ROM (that is, in a readable non-transitory tangible storage medium). The hardware process may be implemented by a special purpose electronic circuit.

Based on the detection values of the first current sensor 125, the first rotation angle sensor 126, and the first torque detector 194, the first control part 130 generates a control signal. The control signal controls to turn on and off the switching element 121 of the first inverter circuit 120 by current feedback control, for example. Based on the detection values of the second current sensor 225, the second rotation angle sensor 226, and the second torque detector 294, the second control part 230 generates a control signal. The control signal controls to turn on and off the switching element 221 of the second inverter circuit 220 by current feedback control, for example. Based on the control signals, the switching elements 121 and 221 are actuated. By controlling the energization of the motor windings 180 and 280, the driving of the motor 80 is controlled. The details of the motor driving control may be anything.

As shown in FIG. 5, the vehicle communication network 350 communicably connects the EPS-ECU 10 and other ECUs 361, 362 such as, for example, an engine ECU. The first control part 130 can communicate with an external device 400 having an external diagnosis tool 401 via the vehicle communication network 350 and a detachable connection wiring 410. By contrast, the second control part 230 is not connected to the vehicle communication network 350 connectable to the external device 400. It may be possible to improve security performance by separating the second control part 230 from the vehicle communication network 350. Though not shown in the drawings, the second control part 230 may be connected to a communication network other than the vehicle communication network 350, the communication network connecting a part of ECUs such as an ECU for automatic driving control, for example.

In response to a request from the external diagnostic tool 401, the control parts 130 and 230 in the embodiment can execute the reprograming process for updating various programs written in the ROM or the like. The control parts 130 and 230 execute the reprograming process in response to a reprograming request from the external diagnostic tool 401. As shown by a two-dot chain line in FIG. 5, the reprograming process may be executed by OTA (on the air) by wireless communication via a wireless communication part 351.

For example, it is assumed that both the first control part 130 and the second control part 230 are connected to the external diagnostic tool 401 via the vehicle communication network 350, and reprogramming is performed in each. When the reprogramming is permitted in one of the first control part 130 and the second control part 230 and the reprograming is not permitted (rejected) in the other, only one of the first control part 130 and the second control part 230 goes into a reprogramming process. The program versions may be different between the control parts. As the embodiment, when the second control part 230 is not connected to the vehicle communication network 350, a state of the second control part 230 is not directly determined by the external diagnostic tool 401.

In the embodiment, the second control part 230 acquires the reprograming process request via the inter-microcomputer communication from the first control part 130. It may be possible to execute the reprograming process. When all of the control parts 130 and 230 permits the reprograming process, the reprograming process is executed. When at least one of the control parts 130 or 232 rejects the reprograming process, the reprograming process is prohibited. When all of the control parts 130 and 230 have succeeded in the reprograming process, a reprograming success is responded (transmitted) to the external diagnostic tool 401. When at least one of the control parts 130 or 232 has failed the reprograming process, a reprograming failure is responded to the external diagnostic tool 401.

In details, in the embodiment, the external diagnostic tool 401 transmits the reprograming process request to the first control part 130. The second control part 230 notifies the first control part 130 of whether to have permitted the reprograming process of the second control part 230. When at least one of the control parts 130 or 230 cannot execute the reprograming process, the first control part 130 notifies the external diagnostic tool 401 that the reprograming process cannot be executed.

When both of the control parts 130 and 230 can execute the reprograming process, the first control part 130 transmits the reprograming process request to the second control part 230. The control parts 130 and 230 execute the reprograming process. The second control part 230 transmits to the first control part 130, information of whether the reprograming process is successful. When the control parts 130 and 230 have completed the reprograming process, the first control part 130 notifies the external diagnosis tool 401 of information indicating that reprograming process is successful. When at least one of the control parts 130 or 230 has failed the reprograming process, the first control part 130 notifies the external diagnostic tool 401 of information indicating that the reprograming process has been failed.

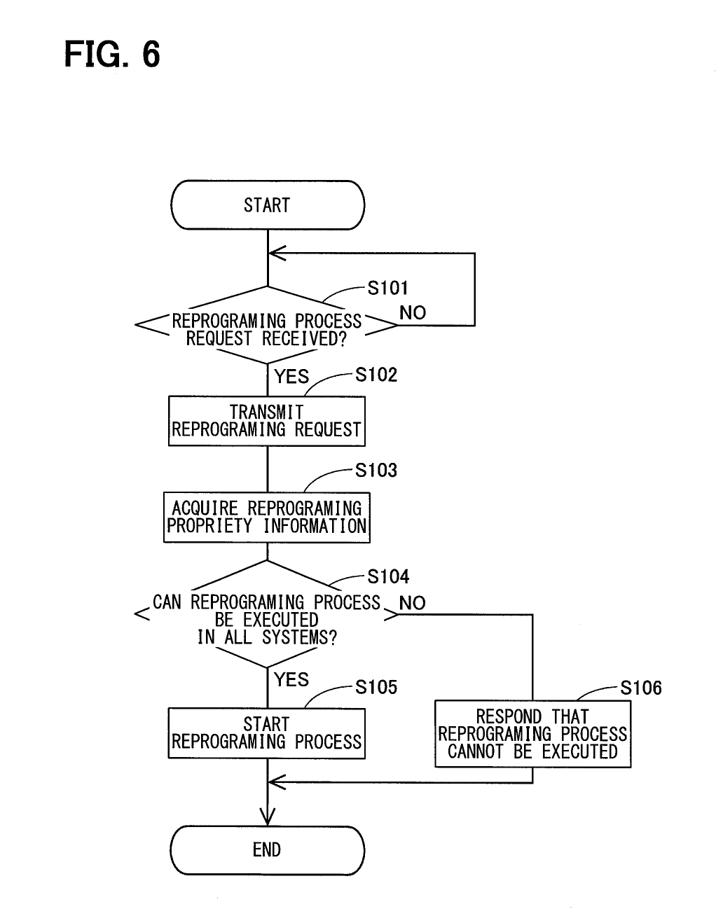

FIG. 6 is a flowchart showing the reprograming start process. The process is executed by the first control part 130. In the embodiment, “step” of step S101 is simply referred to as a symbol “5”. The same applies to the other steps.

In S101, the first control part 130 determines whether to have received the reprograming process request from the external diagnostic tool 401. When determining that the reprograming process request has not been received (S101: NO), this determination process is repeated. When determining that the first control part 130 has received the reprograming process request (S101: YES), the process shifts to S102.

In S102, the first control part 130 transmits the reprograming process request to the second control part 230. In S103, the first control part 130 internally acquires information indicating whether the first control part 130 can execute the reprograming process. The first control part 130 acquires from the second control part 230, information indicating whether the second control part 230 can execute the reprograming process. For example, status information or the like in the communication frame is transmitted and received between the control parts 130 and 230. When performing determination in S104 based on the state information separately from the reprograming process, the processes in S102 and S103 may be omitted.

In S104, the first control part 130 determines whether all systems can execute the reprograming process based on an own system reprograming propriety information and the other system reprograming propriety information (also referred to as a different system reprograming propriety information). While rewriting a program, a steering assist is impossible (cannot be performed) for a certain period. Therefore, it is determined that the reprograming process can be executed in a situation where the vehicle does not drive surely, that is, in a situation where a steering assist is unnecessary. In other words, when it is supposed that the assist of the steering is necessary while executing the reprograming process, the reprograming process is prohibited. When determining that the all systems can execute the reprograming process (S104: YES), the process shifts to S105. When determining that at least a part of the systems cannot execute the reprograming process (S104: NO), the process shifts to S106. When the inter-microcomputer communication is abnormal, the first control part 130 cannot transmit a reprograming execution command or the like to the second control part 230. Therefore, it is determined that the second control part 230 cannot execute the reprograming process.

In S105, the first control part 130 notifies the second control part 230 of the reprograming execution command, and starts the reprograming process of the first control part. The second control part 230 receives the update program together with the reprograming execution command from the first control part 130, and starts the reprograming process of the second control part 230 asynchronously. When normally completing the reprograming process, the second control part 230 transmits information indicating reprograming success to the first control part 130. When not normally completing the reprograming process, the second control part 230 transmits information indicating the reprograming failure to the first control part 130. In S106, the first control part 130 responds to the external diagnostic tool 401 that the reprograming process cannot be executed.

In the embodiment, when determining that all systems can execute the reprograming process, the process shifts to S105. In S105, the update program is downloaded from the external diagnostic tool 401. In S101, the update program is downloaded together with the reprograming process request. When it determined that all systems can execute the reprograming process, the update program may be rewritten.

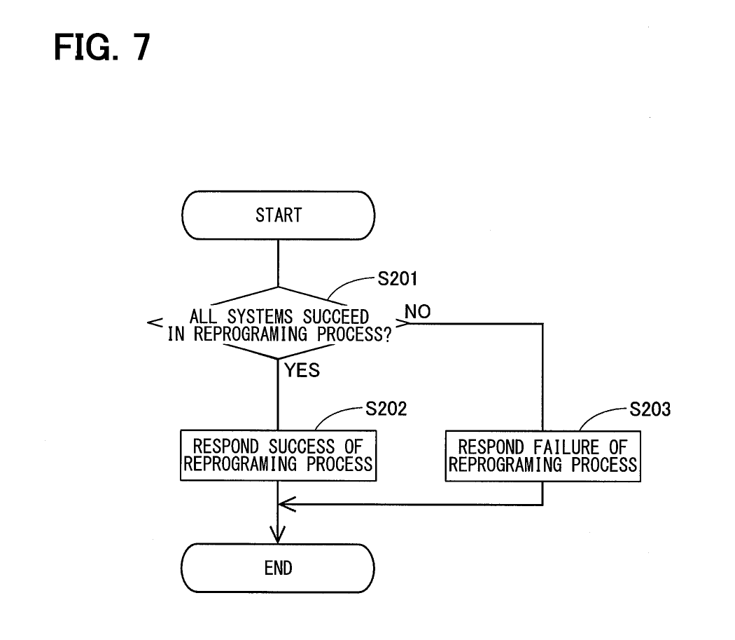

FIG. 7 is a flowchart showing the reprograming completion notification process. The process is executed by the first control part 130. In S201, the first control part 130 determines whether all systems have succeeded in the reprograming process. When determining that all systems has succeeded in the reprograming process (S201: YES), the process shifts to S202. When determining that at least a part of the systems has failed the reprograming process (S201: NO), the process shifts to S203.

In S202, the first control part 130 responds reprograming success to the external diagnostic tool 401. In S203, the first control part 130 responds the reprograming failure to the external diagnostic tool 401.

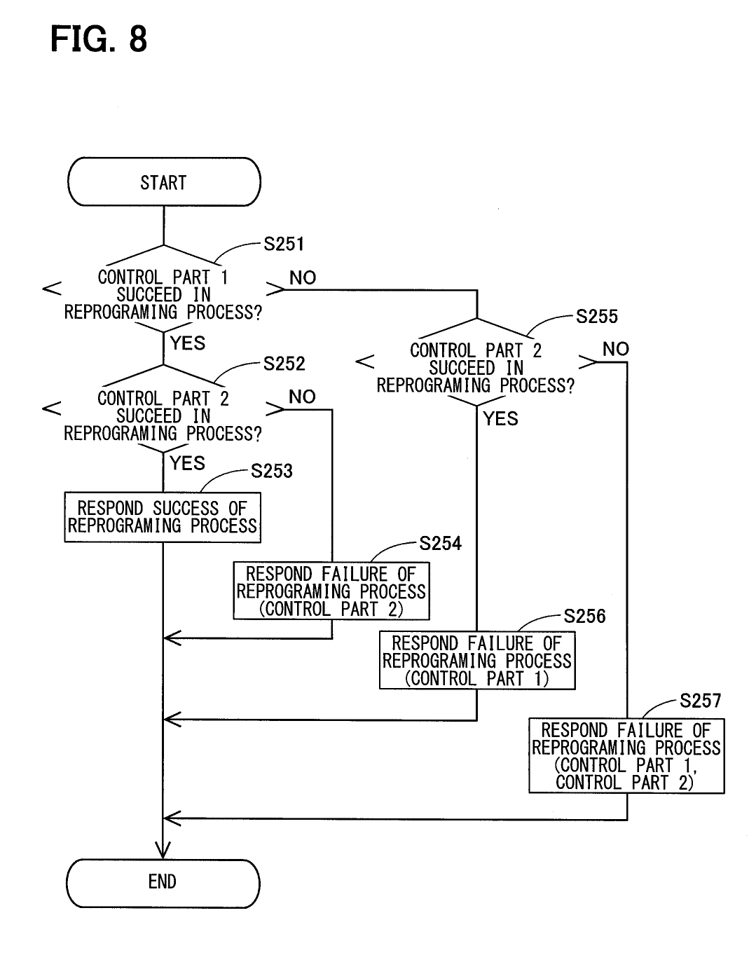

The reprograming completion notification process may be executed as shown in FIG. 8. In S251, the first control part 130 determines whether the first control part 130 has succeeded in the reprograming process. When determining that the first control part 130 has succeeded in the reprograming process (S251: YES), the process shifts to S252. When determining that the first control part 130 has failed the reprograming process (S251: NO), the process shifts to S255.

In S252, the first control part 130 determines whether the second control part 230 has succeeded in the reprograming process. When determining that the second control part 230 has succeeded in the reprograming process (S252: YES), the process shifts to S253. The first control part 130 responds to the external diagnostic tool 401 of the reprograming success. When determining that the second control part 230 has failed the reprograming process (S252: NO), the process shifts to S254. The first control part 130 responds to the external diagnostic tool 401 of the reprograming failure, and notifies the external diagnostic tool 401 that the control part in which the reprograming process has failed the reprograming process is the second control part 230.

In S255, similarly to S252, the first control part 130 determines whether the second control part 230 has succeeded in the reprograming process. When determining the second control part 230 has succeeded in the reprograming process (S255: YES), the process shifts to S256. The first control part 130 responds to the external diagnostic tool 401 of the reprograming failure, and notifies the external diagnostic tool 401 that the control part failing the reprograming process is the first control part 130. When determining the second control part 230 has failed the reprograming process (S255: NO), the process shifts to S257. The first control part 130 responds to the external diagnostic tool 401 of the reprograming failure, and notifies the external diagnostic tool 401 that the control parts failing the reprograming process is both the first control part 130 and the second control part 230.

When executing the reprograming process, the control parts 130 and 230 hold program before the reprograming process. When one of the control parts 130 or 230 has succeeded in the reprograming process and the other has failed the reprograming process, the first control part 130 validates the program before the reprograming process even in the control part succeeding in the reprograming process. The first control part 130 commands the control parts 130 and 230 to invalidate the update program. The versions of the program in the control parts 130 and 230 are same. Alternatively, when it is necessary to invalidate to employ the program before the reprograming process due to a defect of the program or the like, driving of the system may shift to a driving of a one-system. In the driving of the one-system, the control part succeeding in the reprograming process employs the update program.

When executing the reprograming process in the OTA, an usage condition of the vehicle 300 is not accurately determined by the external device 400. Therefore, it may be preferable to start the reprograming process in a situation where the vehicle 300 does not drive surely, that is, in a situation where the assist by the electric power steering apparatus 8 is unnecessary. However, the reprograming process cannot be executed unless the control parts 130 and 230 activate. According to a preferrable configuration, the reprograming process is executed in a first state or a second state. In the first state, a start switch such as an ignition power supply turns on to activate the control parts 130 and 230, and also the power supply supplied to a power system turns off to prevent generation of the assist. In the second state, the vehicle 300 cannot travel. It may be preferable to be configured to notify a user of information indicating the reprogramming process is executed with display of an instrument panel or the like.

The EPS-ECU 10 in the embodiment controls the electric power steering apparatus 8 including the motor 80. The EPS-ECU 10 includes the first control part 130 and the second control part 230. The first control part 130 can communicate with the external device 400, and execute the specific process in response to a request from the external device 400. The second control part 230 can communicate with the first control part 130, receive the command from the first control part 130, and execute the specific process. The specific process of the embodiment is a reprograming process of updating a program.

The first control part 130 can acquire first information related to an execution propriety state of the specific process of the first control part 130 and second information related to the execution propriety state of the specific process of the second control part 230. When all of the first information and the second information are positive (or affirmative), the first control part 130 transmits positive information to the external device 400. When at least a part of the first information or the second information is negative (or inaffirmative), the first control part 130 transmits negative information to the external device 400. The “execution propriety state” in the embodiment is a concept including a state of whether to have permitted the execution of the reprograming process and a state of whether to have completed the reprograming process. For example, the positive information is predetermined information indicating that own control part can execute the specific process. The negative information is predetermined information indicating that own control part cannot execute the specific process. The case where all of the first information and the second information are positive may include a case where the electric power steering apparatus 8 does not assist a steering. The case where a part of the first information and the second information is negative includes a case where the electric power steering apparatus 8 assists the steering.

It may be possible to cause the first control part 130 and the second control part 230 to cooperate with each other and to execute the specific process. As the embodiment, even when the second control part 230 is not connected to the external device 400, the second control part 230 can execute the specific process. It may be possible to notify the external device 400 of the execution propriety state of the specific process of the EPS-ECU 10.

In the embodiment, the first information and the second information indicate whether to have permitted the execution of the reprograming process. When all of the control parts 130 and 230 can execute the reprograming process, the first control part 130 executes the reprograming process of the first control part 130 and commands the second control part 230 to execute the reprograming process. When receiving the reprograming execution command for the execution of the reprograming process from the first control part 130, the second control part 230 executes the reprograming process of the second control part 230. In the embodiment, the first control part 130 and the second control part 230 execute the specific process asynchronously. It may be possible to appropriately execute the reprograming process of the multiple control parts 130 and 230 from one external diagnosis tool 401. It may be possible to prevent from be different in the versions of the program for each of the control parts, the difference being caused by a state where the apart of the control parts cannot execute the reprograming process and the other control part executes the reprograming process.

When all of the first control part 130 and the second control part 230 can execute the reprograming process, the first control part 130 transmits the update program to the second control part 230. When assisting the steering, the first control part 130 and the second control part 230 prohibit the reprograming process. The control parts 130 and 230 can appropriately execute the reprograming process.

In the embodiment, the first information and the second information indicate whether to the execution of the reprograming process is successful. The second control part 230 transmits to the first control part 130, information of whether the reprograming process of the second control part 230 is successful. When at least a part of the first control part 130 or the second control part 230 has failed the reprograming process, the first control part 130 validates the program before the execution of the reprograming process of the first control part 130, and commands the second control part 230 to validate the program before the execution of the reprograming process of the second control part 230. In response to the command from the first control part 130, the second control part 230 validates the program before the execution of the reprograming process. It may be possible to match the version of the programs of the control parts 130 and 230. It may be possible to prevent the inconsistency caused by the difference of the version of the program.

### Second Embodiment

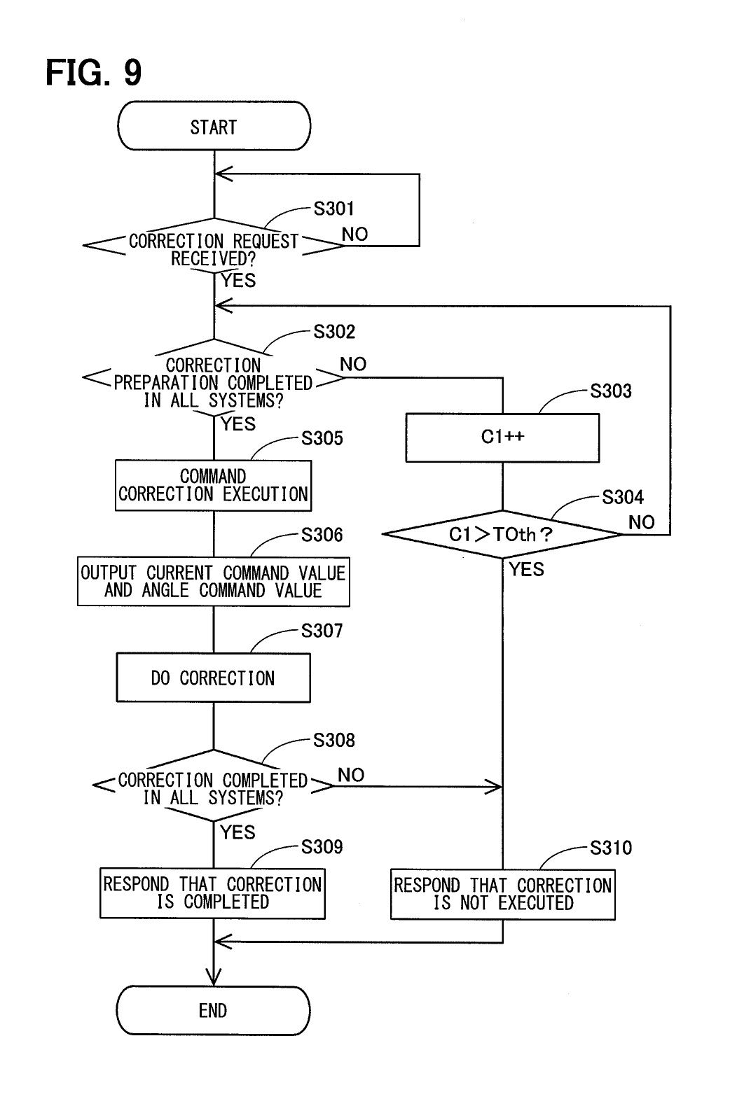

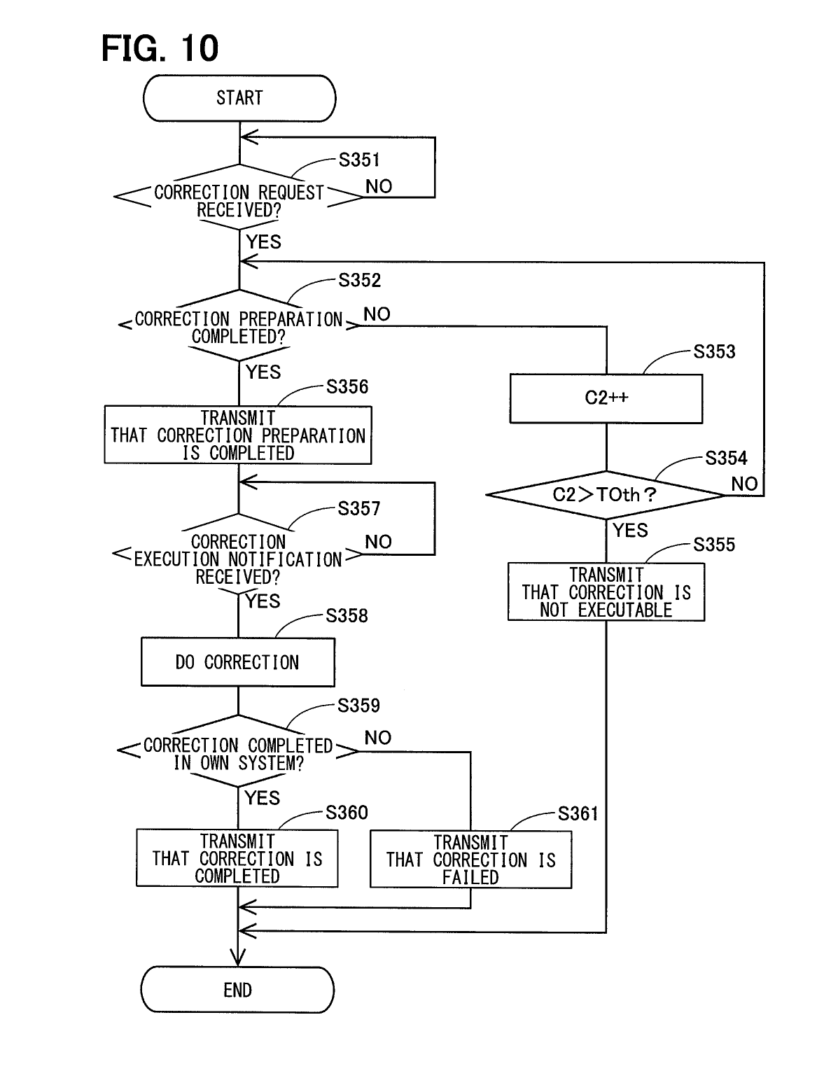

FIG. 9 and FIG. 10 show a second embodiment. According to the first embodiment, the reprograming process is described as an example of the specific process. In this embodiment, a sensor correction process will be described as an example of the specific process. In the embodiment, instead of the reprograming process request in FIG. 5, a sensor correction process request is transmitted and received. Instead of the information indicating permission or rejection for the reprograming process and the information indicating success or failure for the reprograming process, information indicating permission or rejection for the sensor correction and information indicating success or failure for the sensor correction are transmitted and received. When the sensor correction process is executed in a state where the motor 80 is energized, the first control part 130 transmits a current command value and an angle command value to the second control part 230. In the embodiment, the first control part 130 transmits the current command value and the angle command value. Alternatively, the second control part 230 may transmit the current command value and the angle command value in response to the correction command.

As described in the above embodiment, since the second control part 230 is not connected to the vehicle communication network 350 and cannot directly acquire a sensor correction request from the external device 400, the second control part 230 can acquire the sensor correction request in the inter-microcomputer communication from the first control part 130.

The embodiment includes the multiple control parts. Therefore, when a part of the control parts cannot execute the sensor correction and the other control part executes the sensor correction, the inconsistency or error of the detection may occur. In the embodiment, when all of the control parts 130 and 230 have succeeded in the correction, the correction success is notified to the external device 400. When at least a part of the control parts 130 or 230 has failed the correction, it is responded that the correction is not executed or failed.

For example, in such a case of correcting the order corresponding to the rotation of the rotation angle sensors 126 and 226, correcting gain of the torque sensor 94, the current sensors 125 and 225, or the like, it is necessary that the motor 80 is driven to execute the correction in a dynamic state. In the case, when a difference of process moment occurs between the systems, the correction may not be executed in an intended state. In the embodiment, the control parts 130 and 230 execute a sensor error correction in synchronization.

The sensor correction process in the embodiment will be described with reference to flowcharts of FIG. 9 and FIG. 10. FIG. 9 shows the process of the first control part 130. FIG. 10 shows the process of the second control part 230. A correction target may be any sensor placed corresponding to each of the control parts 130 and 230. In order to remove an external factor, the sensor correction process is executed when the sensor correction is executable. For example, when a vehicle speed is equal to or less than a vehicle speed determination threshold value, a steering torque is equal to or less than a torque determination threshold value, and a steering angular velocity is equal to or less than a steering angular velocity determination threshold value, the sensor correction process is executed. Whether to execute the sensor correction process is determined based on the vehicle speed, the steering torque, and the steering angular velocity. However, at least a part of the vehicle speed, the steering torque, or the steering angular velocity may be omitted, or the execution propriety of the sensor correction process may be determined based on the other parameter.

As shown in FIG. 9, in S301, the first control part 130 determines whether to have received the sensor correction request from the external diagnostic tool 401. When determining that the sensor correction request is not received (S301: NO), this determination process is repeated. When determining that the sensor correction request has been received (S301: YES), the process shifts to S302.

In S302, the first control part 130 determines whether all systems have completed a correction preparation. When determining that all systems have completed the correction preparation (S302: YES), the process shifts to S305. When determining that at least a part of the systems has not completed the correction preparation (S302: NO), the process shifts to S303.

In S303, the first control part 130 increments a timeout counter C1. In S304, it is determined whether the timeout counter C1 is larger than a determination threshold TOth. When determining that the timeout counter C1 is equal to or less than the determination threshold TOth (S304: NO), the process shifts to S302. When determining that the timeout counter C1 is larger than the determination threshold TOth (S304: YES), the process shifts to S310.

When determining that correction preparations of all systems have been completed (S302: YES), the process shifts to S305. In S305, the first control part 130 commands the second control part 230 to execute the correction. In S306, the first control part 130 outputs a current command value and an angle command value for driving the motor 80. In S307, the sensor correction in response to the correction request is performed.

In S308, the first control part 130 determines whether all systems complete the correction. When determining that the correction of the all systems has been completed (S308: YES), the process shifts to S309. The correction completion is responded to the external diagnostic tool 401. When determining that the correction of the all systems has not been completed (S308: NO), the process shifts to S310. It is responded to the external diagnostic tool 401 that the sensor correction has not been executed. When determining as negative in S308, the timeout count process similarly to S303 and S304 may be executed.

As shown in FIG. 10, the second control part 230 determines whether to have received the correction request from the first control part 130. When determining not to have received the correction request (S351: NO), the determination process is repeated. When determining to have received the correction request (S351: YES), the process shifts to S352.

In S352, the second control part 230 determines whether to have completed the correction preparation of the own system. When determining to have completed the correction preparation in the own system (S352: YES), the process shifts to S356. When determining not to have completed the correction preparation of the own system (S352: NO), the process shifts to S353.

In S353, the second control part 230 increments a timeout counter C2. In S354, it is determined whether the timeout counter C2 is larger than the determination threshold TOth. The determination threshold TOth may be same as or different from the value related to the timeout determination of the first control part 130. When determining that the timeout counter C2 is equal to or less than the determination threshold TOth (S354: NO), the process shifts to S352. When determining that the timeout counter C2 is larger than the determination threshold TOth (S354: YES), the process shifts to S355. The second control part 230 transmits information indicating that the own system cannot execute the correction to the first control part 130.

When determining to have completed the correction preparation of the own system (S352: YES), the process shifts to S356. In S356, the second control part 230 transmits the information indicating to have completed the correction preparation to the first control part 130.

In S357, the second control part 230 determines whether to have received the correction execution from the first control part 130. When determining not to have received the correction execution (S357: NO), the determination process is repeated. When having reached timeout or received the command not to execute the correction from the first control part 130, the second control part 230 does not execute the process of S358 and the following, and the routine ends. When determining to have received the command to execute the correction (S357: YES), the process shifts to S358. The second control part 230 executes the sensor correction corresponding to the correction request.

In S359, the second control part 230 determines whether to have completed the correction of the own system. When determining to have completed the correction of the own system (S359: YES), the process shifts to S360. The second control part 230 transmits the sensor correction completion to the first control part 130. When determining not to have completed the correction of the own system (S359: NO), the process shifts to S361. The second control part 230 transmits the sensor correction failure to the first control part 130. Similarly to a case of determining as negative in S308, the timeout count process may be executed.

FIG. 9 and FIG. 10 describe that the sensor correction process is executed by driving the motor 80 in the sensor correction. However, when correction is executed in a static state where the motor 80 is not driven, for example, offset correction, sensor correction, the sensor correction process may be executed at the moment for each of the control parts 130 and 230 without synchronizing the sensor correction process. In the reprograming process described in the first embodiment, the control parts 130 and 230 may synchronize a reprograming start moment similarly to the embodiment.

In a case of employing the external diagnostic tool 401, when the sensor correction is executed in a factory or when an abnormality is detected in any of the systems, a temporary factor such as the noise or fluctuation of a power supply voltage may occur. Therefore, recorrection may be tried. When completing the correction, the abnormality may be solved. By contrast, when the abnormality is detected over multiple times, the abnormality may occur in the ECU 10 or a communication line. Therefore, the specific process of an abnormal part is executed separately. When identifying as the abnormality of the ECU 10, the correction may be executed after replacement of the ECU 10. At the time of the abnormality, by performing addressing such as stopping of the assist, notification by a buzzer, a warning lamp, or the like, the abnormal part may be addressed so as to be held in the factory with maintaining the abnormality.

When executing a remote correction by OTA, the correction value before the remote correction is retained. When the abnormality occurs, the correction value returns to the state before the correction. Regarding remote correction, it may try multiple corrections in consideration of the temporary factor. Even when the correction fails in a case of executing the multiple corrections, the warning by the warning lamp or the like may be performed.

In a case of executing the remote correction, when a part of the control parts 130 and 230 has succeeded in the correction, the control part succeeding in the correction may employ a value after the correction. Furthermore, for example, when the difference between the values before and after the correction is larger than a predesigned threshold value, a reliability of the correction value may be regarded as low and the value before the correction may be employed. Before the completion of writing the correction value by the remote correction, when an abnormality such as damage of the program occurs or when doubt of the abnormality occurs, the system where the abnormality or the doubt occurs stops to drive. In order to prompt user to repair, the warning by the warning lamp or the like may be performed.

The electric power steering apparatus 8 has a first sensor for outputting the detection value to the first control part 130 and a second sensor for outputting the detection value to the second control part 230. The first sensor includes a first current sensor 125, a first rotation angle sensor 126, and the first torque detector 194. The second sensor includes a second current sensor 225, a second rotation angle sensor 226, and the second torque detector 294.

The specific process in the embodiment corresponds to the sensor correction process that corrects the detection values acquired from the first sensor and the second sensor. The first control part 130 and the second control part 230 synchronize based on a specific process start command from the first control part 130. The first control part 130 and the second control part 230 start the specific process. It may be possible to appropriately execute the sensor correction process. In particular, when the sensor correction process is executed by the driving of the motor 80, the sensor correction process is executed in the synchronization. It may be possible to prevent the error correction caused by the difference between the process moments.

The “execution propriety state” in the embodiment is a concept including a state of whether to have permitted the execution of the sensor correction process and a state of whether to have completed the sensor correction process.

### Third Embodiment

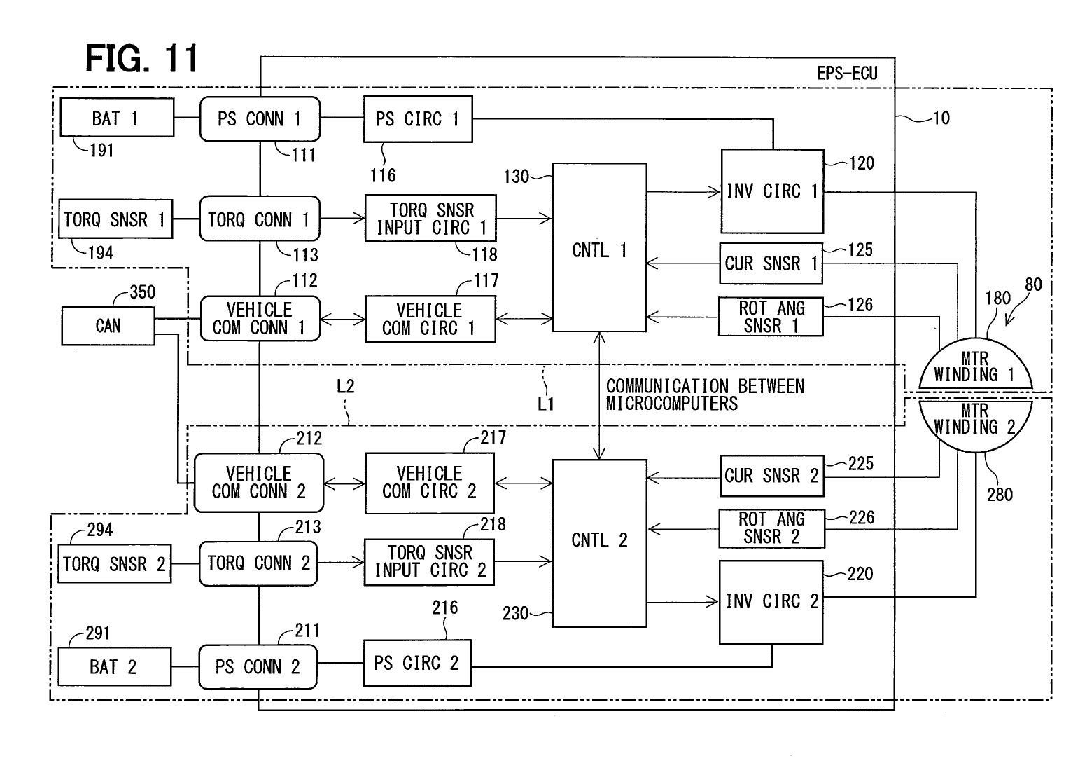

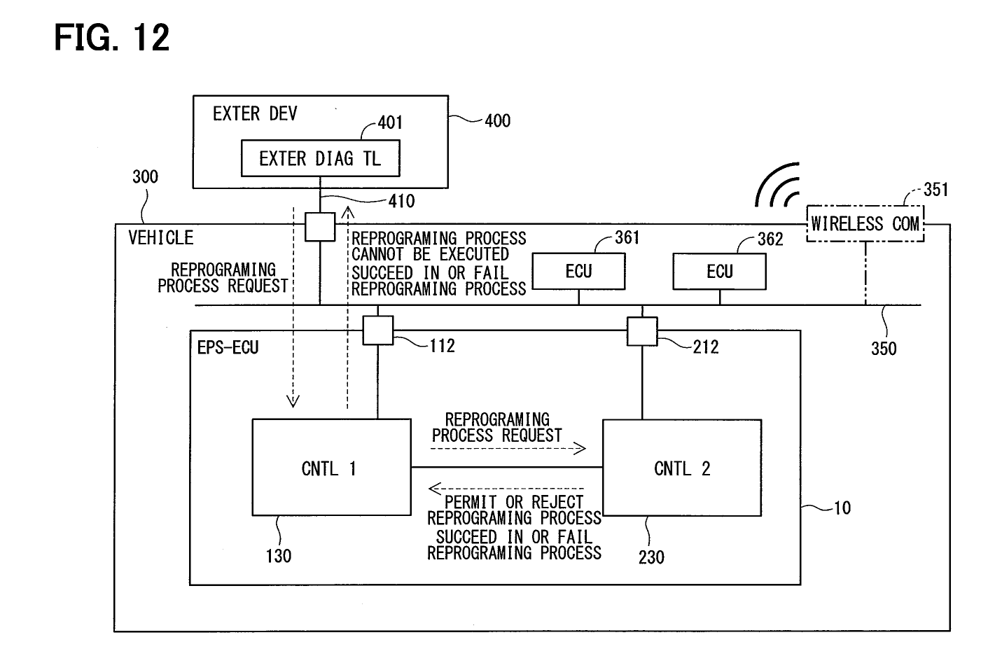

FIG. 11 and FIG. 12 show a third embodiment. As shown in FIG. 11 and FIG. 12, a second vehicle communication connector 212 is connected to the second control part 230 via a second vehicle communication circuit 217. The second communication connector 212 is placed in the EPS-ECU 10 in the embodiment. The second vehicle communication connector 212 is connected to the vehicle communication network 350. That is, in the embodiment, both the first control part 130 and the second control part 230 are connected to the vehicle communication network 350. Even when the second control part 230 is connected to the vehicle communication network 350, similarly to the first embodiment, the second control part 230 executes the reprograming process in response to the reprograming process request from the first control part 130. The second control part 230 transmits the execution propriety of the reprograming process and a success propriety of the reprograming process to the first control part 130. The similar applies to the sensor correction process described in the second embodiment. Such a configuration also provides the similar effect as the embodiment described above.

### OTHER EMBODIMENTS

In the above embodiment, two control parts are placed, one is a first control part and the other is a second control part. In the other embodiments, the number of the control parts may be three or more. In the case, one control part is the first control part, and the other control part is the second control part. That is, the number of the second control parts may be plural. In the above embodiment, the specific process corresponds to the reprograming process or the sensor correction process. In the other embodiments, the specific process may be executed in response to the request from the external device. The specific process may be another process requiring the cooperation between the multiple control parts.

In the embodiment, the first sensor and the second sensor corresponds to the current sensor, the motor rotation angle sensor and the torque sensor. In the other embodiments, as the first sensor and the second sensor, at least a part of the current sensor, the motor rotation angle sensor, or the torque sensor may be omitted. The first sensor and the second sensor may include another sensor such as a voltage sensor or a temperature sensor.

In the embodiment described above, the rotation electric machine corresponds to a three phase brushless motor. In the embodiments, the rotation electric machine is not limited to the three phase brushless motor and may be any motor. The rotation electric machine is not limited to the motor, and may be a generator, or may be a so-called motor generator having both functions of an electric machine and an electric generation machine. In the above embodiment, the driving device is an electromechanical integral type in which the ECU and the motor are integrated. In the embodiments, the driving device may be an electromechanical integral type in which the ECU is separated from the motor. The present disclosure is not limited to the embodiments described above, and various modifications are employable within the scope of the present disclosure without departing from the spirit of the present disclosure.

What is claimed is:

1. A steering control apparatus comprising:
a first control part configured to communicate with an external device and execute a specific process in response to a request from the external device; and
a second control part configured to communicate with the first control part, and receive a command from the first control part to execute the specific process,
wherein:
the steering control apparatus is configured to control an electric power steering apparatus including a rotation electric machine;
the first control part is configured to acquire
first information related to an execution propriety state of the specific process of the first control part, and
second information related to the execution propriety state of the specific process of the second control part;
in a case where all of the first information and the second information are positive, the first control part is configured to transmit positive information to the external device; and
in a case where a part of the first information and the second information is negative, the first control part is configured to transmit negative information to the external device.

2. The steering control apparatus according claim 1, wherein:
the first control part and the second control part are configured to be synchronized and start the specific process, based on a specific process start command of the first control part.

3. The steering control apparatus according to claim 1, wherein:
the first control part and the second control part are configured to asynchronously execute the specific process.

4. The steering control apparatus according to claim 1, wherein:
the specific process is a reprogramming process in which a program is updated.

5. The steering control apparatus according to claim 4, wherein:
each of the first information and the second information indicates whether to permit to execute the reprogramming process;
when all of the first control part and the second control part are able to execute the reprogramming process, the first control part executes the reprogramming process of the first control part, and commands the second control part to execute the reprogramming process; and
when the second control part receives a command for executing the reprogramming process from the first control part, the second control part executes the reprogramming process of the second control part.

6. The steering control apparatus according to claim 5, wherein:
when all of the first control part and the second control part are able to execute the reprogramming process, the first control part transmits an update program to the second control part.

7. The steering control apparatus according to claim 1, wherein:
while the electric power steering apparatus assists a steering, the first control part and the second control part prohibit the reprogramming process.

8. The steering control apparatus according to claim 4, wherein:
each of the first information and the second information indicates whether to succeed the reprogramming process;
the second control part is configured to transmit to the first control part, information indicating whether the reprogramming process of the second control part is successful; and
when at least a part of the first control part or the second control part fails the reprogramming process,
the first control part is configured to validate a program before the reprogramming process and transmit a command for validating the program before the reprogramming process of the second control part, to the second control part, and
the second control part is configured to validate the program before the reprogramming process in response to the command from the first control part.

9. A steering control system comprising:
the steering control apparatus according to claim 1; and
the electric power steering apparatus according to claim 1,
wherein:
the electric power steering apparatus has a first sensor configured to detect a first detection value and output the first detection value to the first control part, and a second sensor configured to detect a second detection value and output the second detection value to the second control part; and
the specific process is a sensor correction process in which a detection value acquired by at least one of the first sensor or the second the second sensor is corrected.

10. The steering control apparatus according to claim 1, wherein:
the case where all of the first information and the second information are positive includes
a case where the electric power steering apparatus does not assist a steering; and
the case where a part of the first information and the second information is negative includes
a case where the electric power steering apparatus assists the steering.

11. A steering control apparatus comprising:
an ECU including
a first control part configured to communicate with an external device and execute a specific process in response to a request from the external device, and
a second control part configured to communicate with the first control part, receive a command from the first control part, and execute the specific process,
wherein:
the first control part is configured to acquire
first information related to an execution propriety state of the specific process of the first control part, and
second information related to the execution propriety state of the specific process of the second control part;
in a case where all of the first information and the second information are positive, the first control part is configured to transmit positive information to the external device; and
in a case where a part of the first information and the second information is negative, the first control part is configured to transmit negative information to the external device.
